(19) United States
(12) Patent Application Publication
(10) Pub. No.: US 2003/0188450 A1
(43) Pub. Date: Oct. 9, 2003

(54) Fabric softener system and method for use in clothes dryer

(75) Inventors: J. Michael Ogden, Cincinnati, OH (US); Robert O. Stiens, West Chester, OH (US); Thomas J. Stiens, Edgewood, KY (US); Richard J. Stiens, Cincinnati, OH (US)

Correspondence Address: HOLLAND & KNIGHT, LLP, ONE EAST BROWARD BLVD., SUITE 1300, FT LAUDERDALE, FL, 33301

(73) Assignee: Ogden & Company, Inc.

(21) Appl. No.: 10/119,343

(22) Filed: Apr. 8, 2002

(51) Int. Cl. F26B 11/02; D06F 58/00

(52) U.S. Cl. 34/597; 34/130; 34/595

(57) ABSTRACT

A fabric softening system comprises a liquid fabric softening composition which is carried in liquid form within a substrate, which is introduced into a rotary clothes dryer with laundered, wet clothing where the softening composition is released into the fabric of the articles of clothing to impart both softening and anti-static properties.

### FIELD OF THE INVENTION

This invention relates to a system and method for softening fabrics, and, more particularly, to the combination of a liquid fabric softening composition and a substrate which is effective to absorb the composition, retain it in liquid form therein and release an effective amount of the composition into clothing within a clothes dryer in the course of a drying cycle to impart softness to the articles of clothing.

### BACKGROUND OF THE INVENTION

The treatment of fabric with certain types of chemical compounds to impart softness when washing articles of clothing has been commonly employed in households, commercial laundromats and in the textile industry. The term “softness” refers to a quality of the fabric in which its “hand” or feel to the touch is smooth, pliable and fluffy, as distinguished from coarse or scratchy. In addition to softening agents, chemical compounds used in washing clothing often include anti-static agents to reduce the static cling of the fabric. The term “static cling” refers to the tendency of articles of clothing to adhere to one another after being dried in a clothes dryer as a result of static electrical charges created on the surface of the fabric. Such electrostatic charges can also attract lint and dust to the fabric. The treatment of articles of clothing with softening agents and anti-static agents increases their comfort when worn, and generally reduces wrinkles which makes ironing easier.

There are generally two types of treatment systems for imparting softness and anti-static properties to laundered articles. One system is a liquid fabric softener of the type such as commercially available from The Proctor & Gamble Company of Cincinnati, Ohio under the trademark Downy®. Liquid fabric softeners of this general type are comprised of cationic compounds, and particularly quaternary ammonium and imidazolinium salts, in the form of liquid emulsions. They are introduced into the washing machine and added to the clothing during the rinse cycle.

Although effective in imparting softness and reducing static cling, liquid fabric softeners have a number of deficiencies. One limitation is that they are inconvenient to use. Often sold in relatively large and heavy containers, liquid fabric softeners must be poured into the relatively small cap of the container, a cup or other measuring device to obtain the proper quantity for a particular size load of wash. The liquid softener is then poured into a receptacle in the washing machine where it is held until the rinse cycle begins. It is easy to spill the liquid softener, both when measuring it and pouring into the washing machine, and then one needs to clean the cap or other measuring device after use.

Another problem with liquid fabric softeners is that the entire content of the washing machine is subjected to the softening agent when it is applied in this fashion. It may be desirable to soften only some of the clothes being washed in a particular washing cycle, but in order to do that the clothing must be separated beforehand and additional loads of wash run. This is not only inefficient but uses additional energy and water.

A still further deficiency of liquid fabric softeners is their effect on the flammability of clothing items. According to tests conducted by Consumer Reports, liquid fabric softener added to the rinse water in washing machines accelerates the burn rate of most fabrics tested. For example, in one test, a terry-cloth bathrobe laundered with liquid fabric softener took just 1.9 seconds to burn a five inch path whereas the same fabric without the fabric softener took 13 seconds to burn the same five inch path. Although the rate of burn varies with the type of fabric, seconds count when clothing catches fire.

The second method of imparting softening and anti-static properties to laundered clothing involves the use of “dry dryer sheets,” i.e. sheets of nonwoven material impregnated with a composition usually consisting of a cationic softening agent, antistatic agents, dispersing agents and a fragrance. The softening agent is applied to the nonwoven material and then dried in an oven so that it is completely “dry” when ready for use. One or more dry dryer sheets are placed into a rotary clothes dryer with freshly laundered, wet items of clothing, where they remain for the entire drying cycle. The composition on the sheet of nonwoven material is released in the course of the drying cycle as a result of the heat within the clothes dryer, the moisture in the clothing and contact with the clothing induced by the tumbling action of the rotary dryer.

Although much more convenient to use than liquid fabric softeners, the dry dryer sheets described above also have a number of limitations. First, dry dryer sheets exhibit relatively poor softening capability compared to liquid fabric softeners. One reason for this is that dry dryer sheets depend to a large extent on physical contact with the clothing within the dryer during the drying cycle in order to effectively transfer the softening composition to the clothes. If the dryer sheet becomes trapped within the sleeve of a shirt, a pant leg or the like, it cannot make contact with other articles of clothing within the dryer. Even if the dry dryer sheet freely contacts the clothing during a drying cycle, the softening agent it carries does not penetrate the fabric to the same extent as liquid fabric softener in the rinse cycle of the washing machine.

Another limitation of dry dryer sheets is that a relatively high temperature is required in order to activate the softening agent on the nonwoven sheet and release it into the fabric of the clothing. Most clothes dryers have several heat settings to accommodate different types of clothing. For example, delicate fabrics are preferably dried at lower heat settings and temperatures than clothing made from cotton or the like. At lower heat settings, dry dryer sheets are of marginal effectiveness and therefore delicate fabrics or other clothing dried at lower temperatures may not exhibit the desired softness and feel when worn. This is a pervasive problem in many European countries, as well as other countries around the world, where the high cost of energy makes it a necessity to operate clothes dryers at lower temperatures. On the other hand, it has been observed that clothing dried at high heat settings and temperatures often exhibit an increased amount of static cling and wrinkling. This is true even when the dry dryer sheet is provided with anti-static agents. Furthermore, in addition to creating static cling and wrinkling, high drying temperatures are hard on fabrics, tending to break them down over time.

### SUMMARY OF THE INVENTION

It is therefore among the objectives of this invention to provide a system for softening articles of clothing which is convenient and easy to use, which does not increase the flammability of fabric, which can be selectively applied to clothing without the need for additional washing cycles, which does not depend solely upon contact with items of clothing in the clothes dryer to be effective, and, which is released into the fabric of articles of clothing within a clothes dryer at relatively low operating temperatures.

These objectives are accomplished in a fabric softening system comprising a liquid fabric softening composition which is absorbed within a substrate, preferably the fibers of a sheet of nonwoven material, and then the moist sheet is introduced into a rotary clothes dryer with laundered, wet clothing where the softening composition is released into the fabric of the articles of clothing to impart both softening and anti-static properties.

In one presently preferred embodiment, the liquid fabric softening composition is a liquid comprising a cationic surfactant, an amount of a preservative effective to prevent biological degradation of the composition and the substrate, a fragrance, and a liquid carrier. The composition is introduced into a substrate which is preferably a sheet of absorbent nonwoven material, although other liquid absorbent materials may be utilized such as woven material, open cell foam, sponge and others. The nonwoven material preferably includes highly absorbent fibers capable of absorbing many times their weight in liquid. The composition is sprayed, dipped or otherwise applied to the nonwoven sheet so that it is absorbed by the fibers, and then the moist sheets are packaged in an air tight container. A moist, nonwoven sheet is placed into the interior of a rotary clothes dryer, with wet, laundered clothing, for the duration of a normal drying cycle wherein the liquid fabric softening composition is released into the fabric of the clothing.

A number of important advantages are obtained with the liquid fabric softening system of this invention compared to the prior art. Unlike liquid softening compositions introduced into the washing machine, the nonwoven sheet of this invention is extremely easy and convenient to use—no measuring, no spilling, no heavy container to pour from, no clean up of a measuring cap or cup and no need to separate clothing before washing according to what items are to be softened or not. Further, the fabric softening composition employed in the present invention does not increase the flammability of fabric, which is of particular concern with many liquid fabric softeners currently offered on the market.

Other advantages of the present invention highlight the deficiencies of “dry” dryer sheets now being sold such as the Bounce® dry dryer sheets available from The Proctor & Gamble Company of Cincinnati, Ohio. It has been found that the liquid fabric softening composition applied to the nonwoven sheet according to the present invention is readily released into the fabric of clothing within a clothes dryer operated at comparatively low heat settings or temperatures. Unlike dry dryer sheets which are activated only at high temperatures, the liquid fabric softening composition of the present invention is effective to soften any type of fabric at lower temperatures or even ambient temperature thus reducing static cling, wrinkling and damage to the fabric. Additionally, it is believed that the mechanism for imparting the liquid fabric softening composition of this invention is not wholly dependent upon contact with the clothing in the dryer, as with dry dryer sheets. The liquid fabric softening composition is maintained in liquid form within the nonwoven sheet, and is believed to both physically contact the wet clothing due to the tumbling action of the dryer and at least partially evaporate from the nonwoven sheet in the course of a drying cycle thus becoming entrained in the air flow within the interior of the dryer where it contacts and enters the fibers of the clothing being dried. This increases the efficiency of the softening system of this invention, compared to dry dryer sheets, promotes even distribution of the liquid fabric softening composition throughout the clothing within the dryer, and makes it less likely for the overall softening of clothing within the dryer to be unduly affected should the nonwoven sheet become caught within the sleeve or pant leg of an article of clothing.

### DETAILED DESCRIPTION OF THE INVENTION

The fabric softening system of this invention comprises the combination of a liquid fabric softening composition and a substrate capable of absorbing the composition. The substrate, which retains the liquid fabric softening composition in liquid form therein, is introduced into a clothes dryer with wet, laundered clothing wherein the composition is released into the fabric of the clothing to impart softness and anti-static properties. Each component of the system of this invention is described separately below, followed by illustrative examples.

Liquid Fabric Softener Composition

The liquid fabric softener composition of this invention is prepared by mixing, in desired proportions, the following: (a) a cationic surfactant; (b) a preservative; (c) a fragrance; and (d) a liquid carrier.

The cationic surfactant is preferably stearamidopropyl morpholine lactate which is commercially available under the trademark “Mackalene 326” from the McIntyre Group Ltd. of University Park, Ill. It has a CAS number of 55852-14-7 and the following chemical formula:

C₂₈H₅₆N₂O₅

The material has a boiling point of approximately 100° C., a specific gravity of 1.01, a vapor pressure of approximately 25 mm Hg., a vapor density greater than 1 and an evaporation rate of greater than 1. It is soluble in water. In the presently preferred embodiment, the Mackalene 326 cationic surfactant is specifically manufactured to exhibit a pH in the range of 3.5 to 5.5, and most preferably in the range of 4.0 to 4.8. The cationic surfactant is present in the composition in an amount preferably in the range of about 10% to 99%, more preferably in the range of about 30% to 40%, and, most preferably in an amount of about 38%, by volume.

In order to ensure that no biological degradation occurs in the composition, or in the nonwoven sheet carrying the composition, a preservative is included. One preservative suitable for this purpose is dimethylol dimethyl hydantoin which is commercially available under the trademark “Glydant” from Lonza, Inc. of Fair Lawn, N.J. The preservative is present in the composition in an amount preferably in the range of about 0.20% to 0.80%, more preferably in the range of about 0.25% to 0.45% and most preferably in an amount equal to about 0.30%, by volume.

A number of different fragrances can be employed in the composition to create the desired smell of the clothing softened by the present invention, including, without limitation, rose oil, lavender, lilac, jasmine, vanilla, wisteria, lemon, apple blossom or compound bouquets such as citrus, spice, aldehydic, woods, oriental, baby powder and others. One fragrance suitable for use in the composition is sold under the name Baby Fragrance [C-78-17-B] commercially available from Bell Flavors and Fragrances, Inc. of Middletown, N.Y. The fragrance is present in the composition in an amount preferably in the range of about 0% to 2.5%, more preferably in the range of about 0.5% to 1.5% and most preferably in an amount of about 1%, by volume.

The liquid carrier is preferably deionized water, although the use of water which is not deionized is acceptable. The liquid carrier is present in the composition in an amount preferably in the range of 20% to 90%, more preferably in the range of about 55% to 65% and most preferably in an amount of about 60% by volume.

Substrate

The liquid fabric softener composition is carried by a substrate to form the fabric softening system of this invention. In the presently preferred embodiment, the substrate is formed of a sheet of nonwoven material, although it is contemplated that other materials capable of carrying liquid can be utilized including woven material, foam material, especially open cell foam material, sponge and similar materials.

Nonwoven material is particularly suited to the present application due to its relatively low cost, ease of processing, biodegradation capability and ability to absorb moisture. One presently preferred nonwoven material is fabricated using well known hydroentanglement technology from fibers sold under the “Tencel” trademark which are commercially available from Courtaulds Fibers, Inc. of Axis, Ala. Tencel fibers are manufactured from a solvent spinning process in which wood pulp and amine oxide solution are mixed and heated until the cellulose dissolves. The resulting solution is then extruded into a dilute aqueous solution of the amine oxide, which precipitates the cellulose as fibers. The Tencel fibers exhibit a dry tensile strength in excess of other man-made cellulosic fibers and many synthetics, and have a tensile strength when wet of about 85% of its dry tensile strength. Such fibers absorb liquid up to about 800% of their dry weight, and therefore provide a highly liquid absorbent substrate when hydroentangled to form a nonwoven sheet.

As noted above, the liquid fabric softener composition is described as being “carried” by a substrate and then released into the fabric of clothing during a drying cycle within a clothes dryer. The term “carried” is meant to broadly refer to substrates which absorb liquid, as well as those which exhibit adsorbent properties but nevertheless become wetted when brought into contact with liquid.

It is believed that absorbent materials, and particularly nonwoven materials formed of Tencel fibers or other highly absorbent fibers, provide superior performance in releasing the liquid fabric softening composition of this invention into the fabric of clothing within a clothes dryer. Highly absorbent fibers of this type are effective to trap or retain the composition in liquid form within the structure of the fibers, and then gradually release the composition during the course of a drying cycle under the influence of the tumbling action of the dryer and the application of heat. As a result, the composition is relatively uniformly released into the fabric of the clothing, over a comparatively long period of time, to distribute the composition more evenly and completely to every article of clothing within the dryer.

It is contemplated that other materials which can “carry” liquid would also be useful but less effective in the practice of this invention. For example, nonwoven materials formed from synthetic fibers such as polyester are capable of “carrying” liquid in the sense that they become wetted when brought into contact with liquid. The polyester fibers which comprise such nonwoven materials do not absorb liquid, on the contrary they exhibit adsorbent properties, but liquid can be retained in between the fibers which form the nonwoven material. If the softening composition of this invention were to be applied to a nonwoven material made from polyester fibers, or other materials which exhibit adsorbent properties, it is believed the composition would be released from the nonwoven material in a relatively short period of time within the dryer, compared to absorbent fibers, and provide a lesser degree of uniformity of softening than that which is obtained with absorbent nonwoven materials.

Regardless of whether the nonwoven material or other substrate employed absorbs liquid or merely becomes wetted with liquid, an important aspect of this invention is that the liquid fabric softener composition is “carried” and retained in liquid form by the substrate. The term “liquid form” in the context of the present invention refers to the generally understood state of a fluid in which the fluid has a definite volume without a definite shape except that temporarily given by a container or the like. “Liquid form” does not mean a gel or gelled, or the state of a substance in which it is not flowable. The composition of the present invention is applied and retained in “liquid form” within the substrate in the sense that it has a definite volume, assumes the shape of the substrate and is “flowable,” i.e., can drip from the substrate under the influence of gravity. Since the composition is retained in “liquid form” on the substrate, it can be released evenly onto fabric throughout the interior of the clothes dryer during a drying cycle to effectively impart softness.

### EXAMPLE I

The liquid fabric softening composition was made as follows. A 114 liter drum was charged with 69.51 liters of deionized water at ambient temperature. A container of stearamidopropyl morpholine lactate was checked for uniformity, and then 44.04 liters of same was slowly blended with the water by gentle agitation and stirring. The resulting mixture was checked for pH level, and finding it was within acceptable limits, 1.17 kilograms of Baby Fragrance [C-78-17-B] and 340 milliliters of preservative [“Glydant” preservative] were added until fully dispersed.

### EXAMPLE II

The mixture prepared in accordance with Example I was applied at ambient temperature to a continuous sheet of nonwoven material formed from hydroentangled “Tencel” fibers. The nonwoven sheet was approximately six inches in width, and was transferred by a conveyor beneath a number of spray nozzles connected to a container filled with the mixture. The spray nozzles were operated to deliver the mixture at a rate effective to impregnate the Tencel fibers of the nonwoven material with a quantity of mixture equal to approximately 300% of the dry weight of each fiber. The impregnated nonwoven sheet was then cut into individual sections of approximately eleven inches in length, thus forming discrete nonwoven sheets of about six inches in width and eleven inches in length. The individual sheets were folded and placed in plastic tubs, which were then sealed.

The foregoing examples illustrate a preferred embodiment of the present invention, but it should be understood by those skilled in the art that various changes may be made and equivalents substituted for elements thereof without departing from the scope of the invention.

For example, the term “articles of clothing” has been used throughout to refer to items which are dried within the interior of a clothes dryer. It should be understood that such term “articles of clothing” is intended to be broadly construed as applying to other items which are commonly dried in a clothes dryer, including, without limitation, sheets, towels, rugs and other items made of fabric. Additionally, the term “clothes dryer” or “rotary clothes dryer” refers to a rotary hot air dryer which includes a rotating drum within which articles to be dried are subjected to a flow of heated air typically at a temperature of about 40° C. to 90° C.

Therefore it is intended that the invention not be limited to the particular embodiment disclosed as the best mode contemplated for carrying out the invention, but that the invention will include all embodiments falling within the scope of the appended claims.

Wherefore, we claim:

1. A system for softening the fabric of articles of clothing, comprising:
a substrate;
a liquid fabric softening composition consisting essentially of a softening agent, a preservative and a liquid carrier;
said composition being carried within said substrate which is effective to retain said composition in liquid form therein, said substrate being capable of releasing an effective amount of said composition into the fabric of articles of wet clothing within a clothes dryer during the course of a drying cycle to impart softness to the articles of clothing.

2. The system of claim 1 in which said softening agent is stearamidopropyl morpholine lactate.

3. The system of claim 1 in which said liquid carrier is water.

4. The system of claim 1 in which said preservative is dimethylol dimethyl hydantoin.

5. The system of claim 1 in which said liquid fabric softening composition further includes a fragrance.

6. The system of claim 1 in which said softening agent is present in said liquid fabric softening composition in an amount preferably in the range of about 10% to 99%, by volume.

7. The system of claim 1 in which said softening agent is present in said liquid fabric softening composition in an amount more preferably in the range of about 30% to 40%, by volume.

8. The system of claim 1 in which said softening agent is present in said liquid fabric softening composition in an amount most preferably equal to about 38%, by volume.

9. The system of claim 1 in which said preservative is present in said liquid fabric softening composition in an amount preferably in the range of about 0.20% to 0.80%, by volume.

10. The system of claim 1 in which said preservative is present in said liquid fabric softening composition in an amount more preferably in the range of about 0.25% to 0.45%, by volume.

11. The system of claim 1 in which said preservative is present in said liquid fabric softening composition in an amount most preferably equal to about 0.30%, by volume.

12. The system of claim 1 in which said liquid carrier is present in said liquid fabric softening composition in an amount preferably in the range of about 20% to 90%, by volume.

13. The system of claim 1 in which said liquid carrier is present in said liquid fabric softening composition in an amount more preferably in the range of about 55% to 65%, by volume.

14. The system of claim 1 in which said liquid carrier is present in said liquid fabric softening composition in an amount most preferably equal to about 60%, by volume.

15. The system of claim 1 in which said substrate is a sheet of nonwoven material.

16. The system of claim 15 in which said nonwoven material is formed of cellulosic fibers produced by a solvent spinning process from a solution of wood pulp and amine oxide.

17. The system of claim 16 in which said fibers are capable of absorbing liquid in an amount equal to at least about 300% of their weight.

18. A system for softening the fabric of articles of clothing, comprising:
a substrate;
a liquid fabric softening composition consisting essentially of a softening agent, a preservative, a fragrance and a liquid carrier;
said composition being carried within said substrate which is effective to retain said composition in liquid form therein, said substrate being capable of releasing an effective amount of said composition into the fabric of articles of wet clothing within a clothes dryer during the course of a drying cycle to impart softness to the articles of clothing,

19. The system of claim 18 in which said softening agent is stearamidopropyl morpholine lactate.

20. The system of claim 18 in which said preservative is dimethylol dimethyl hydantoin.

21. The system of claim 18 in which said liquid fabric softening composition consists essentially of about 10% to 99% softening agent, about 0.20% to 0.80% preservative, about 0% to 2.5% fragrance and about 20% to 90% liquid carrier.

22. The system of claim 18 in which said substrate is a sheet of nonwoven material.

23. The system of claim 22 in which said nonwoven material is formed of cellulosic fibers produced by a solvent spinning process from a solution of wood pulp and amine oxide.

24. The system of claim 23 in which said fibers are capable of absorbing liquid in an amount equal to at least about 300% of their weight.

25. The system of claim 18 in which said liquid carrier is water.

26. A system for softening the fabric of articles of clothing, comprising:
a sheet of nonwoven material formed from a plurality of liquid absorbent fibers;
a liquid fabric softening composition consisting essentially of a softening agent, a preservative and a liquid carrier;
said composition being absorbed within said fibers of said sheet of nonwoven material which are effective to retain said composition in liquid form therein, said fibers of said sheet of nonwoven material being capable of releasing an effective amount of said composition into the fabric of articles of wet clothing within a clothes dryer during the course of a drying cycle to impart softness to the articles of clothing.

27. The system of claim 26 in which said softening agent is stearamidopropyl morpholine lactate.

28. The system of claim 26 in which said preservative is dimethylol dimethyl hydantoin.

29. The system of claim 26 in which said liquid carrier is water.

30. The system of claim 26 in which said liquid fabric softening composition further includes a fragrance.

31. The system of claim 25 in which said liquid fabric softening composition consists essentially of about 10% to 99% softening agent, about 0.20% to 0.80% preservative and about 20% to 90% liquid carrier.

32. The system of claim 26 in which said nonwoven material is formed of cellulosic fibers produced by a solvent spinning process from a solution of wood pulp and amine oxide.

33. The system of claim 32 in which said fibers are capable of absorbing liquid in an amount equal to at least about 300% of their weight.

34. The method of imparting a softening agent into the fabric of articles of clothing, comprising:
(a) forming a liquid fabric softening composition consisting essentially of a softening agent, a preservative and a liquid carrier;
(b) applying the liquid fabric softening composition to a substrate which carries and retains the liquid fabric softening composition in liquid form therein;
(c) releasing an effective amount of the liquid fabric softening composition from the substrate into the fabric of articles of clothing within the interior of a clothes dryer in the course of a drying cycle to impart softness to the articles of clothing.

35. The method of claim 34 in which step (c) includes contacting the substrate with items of wet clothing so that the liquid fabric softening composition is transferred into the moisture in the clothing.

36. The method of claim 34 in which step (b) includes providing a substrate comprising a nonwoven material formed of hydroentangled fibers and directing the liquid fabric softening composition into the fibers where it is absorbed.

37. The method of imparting a softening agent into the fabric of articles of clothing, comprising:
(a) forming a liquid fabric softening composition consisting essentially of a softening agent, a preservative and a liquid carrier;
(b) applying the liquid fabric softening composition to a sheet of nonwoven material having liquid absorbent fibers so that the liquid fabric softening composition is absorbed by the fibers and retained in liquid form therein;
(c) releasing an effective amount of the liquid fabric softening composition from the fibers of the sheet of nonwoven material into the fabric of articles of clothing within the interior of a clothes dryer in the course of a drying cycle to impart softness substantially uniformly to the articles of clothing.

38. The method of claim 37 in which step (b) includes forming the liquid absorbent fibers by a solvent spinning process from a solution of wood pulp and oxide.

39. The method of claim 37 in which step (b) includes providing fibers which are capable of absorbing liquid in an amount equal to at least about 300% of their weight.
